(19) United States
(12) Patent Application Publication
(10) Pub. No.: US 2026/0030253 A1
(43) Pub. Date: Jan. 29, 2026

(54) PROCESSING METHOD, EQUIPMENT, AND ELECTRONIC DEVICE

(71) Applicant: Lenovo (Beijing) Limited, Beijing (CN)

(72) Inventors: Zebin ZHENG, Beijing (CN); Jin LIU, Beijing (CN)

(21) Appl. No.: 19/283,206

(22) Filed: Jul. 28, 2025

(30) Foreign Application Priority Data
Jul. 29, 2024 (CN) 202411026069.1

(51) Int. Cl. G06F 16/2457; G06F 16/245; G06F 16/25

(52) U.S. Cl. CPC G06F 16/24578; G06F 16/245; G06F 16/258

(57) ABSTRACT

A processing method includes obtaining input information, the input information including first information in a first form and second information in a second form, the first form being different from the second form; obtaining first process information according to the first information, and obtaining second process information according to the second information; and generating a search request corresponding to the input information according to the first process information and the first form, and the second process information and the second form.

### RELATED APPLICATION(S)

This application claims priority to Chinese Patent Application No. 2024110260691 filed with the China National Intellectual Property Administration (CNIPA) on Jul. 29, 2024, which is incorporated herein by reference in entirety.

### FIELD OF THE TECHNOLOGY

Certain embodiments of the present disclosure relate to a field of information processing, and in particular to a processing method, equipment, and electronic device.

### BACKGROUND

Certain search engines are met with challenges when dealing with multimodal information. These challenges stem from the diversity and complexity of different types of data (such as text, images, audio, and video). Search engines often need to rely on different engines or they process data separately, and may not achieve unified retrieval of multimodal information. In addition, due to the one-sidedness of search results for single-modal information, users often can not attain search results that fully satisfy their needs.

### SUMMARY

In one aspect, the present disclosure provides a processing method. The processing method includes: obtaining input information, the input information including first information in a first form and second information in a second form, the first form being different from the second form; obtaining first process information based on the first information, and obtaining second process information based on the second information; and generating a search request corresponding to the input information based on the first process information and the first form, and the second process information and the second form.

In another aspect, the present disclosure provides an electric device. The electronic device includes: a memory storing computer program instructions; and a processor coupled to the memory and configured to execute the computer program instructions and perform: obtaining input information, the input information including first information in a first form and second information in a second form, the first form being different from the second form; obtaining first process information based on the first information, and obtaining second process information based on the second information; and generating a search request corresponding to the input information based on the first process information and the first form, and the second process information and the second form.

In yet another aspect, the present disclosure provides a non-transitory computer-readable storage medium storing computer program instructions executable by at least one processor to perform: obtaining input information, the input information including first information in a first form and second information in a second form, the first form being different from the second form; obtaining first process information based on the first information, and obtaining second process information based on the second information; and generating a search request corresponding to the input information based on the first process information and the first form, and the second process information and the second form.

### BRIEF DESCRIPTION OF THE DRAWINGS

FIG. 1 is a schematic diagram of an implementation flow of a processing method in certain embodiments of the present disclosure;

FIG. 2 is a schematic diagram of an implementation flow of generating a search request in certain embodiments of the present disclosure;

FIG. 3 is a schematic diagram of an implementation flow of a multimodal search in certain embodiments of the present disclosure;

FIG. 4 is a flowchart of a document search based on a language model in certain embodiments of the present disclosure;

FIG. 5 is a schematic diagram of a composition structure of a processing device in certain embodiments of the present disclosure; and

FIG. 6 is a schematic diagram of a hardware entity of an electronic device in certain embodiments of the present disclosure.

### DETAILED DESCRIPTION

In order to make the purpose, technical solution and advantages of certain embodiments of the present disclosure clearer, technical solution of certain embodiments of the present disclosure are described below in conjunction with the accompanying drawings. The described embodiments are used to illustrate the present disclosure, but are not used to limit the scope of the present disclosure.

When applicable, “certain embodiments” and “certain embodiments” describe a subset of all embodiments, may be the same subset or different subsets of all embodiments, and may be combined with each other without conflict.

When applicable, the terms “first\second\third” are used to distinguish similar objects, and do not necessarily represent a particular order for the objects. The terms “first\second\third” may be interchanged in a particular order or sequence where permitted, so that certain embodiments of the present disclosure may be implemented in an order other than the order illustrated or described here.

Unless otherwise defined, technical and scientific terms mentioned in the present disclosure have the same meaning as those generally understood by technicians in the technical field of the present disclosure. The terms employed are only for the purpose of describing certain embodiments of the present disclosure and are not necessarily intended to limit the scope of the present disclosure.

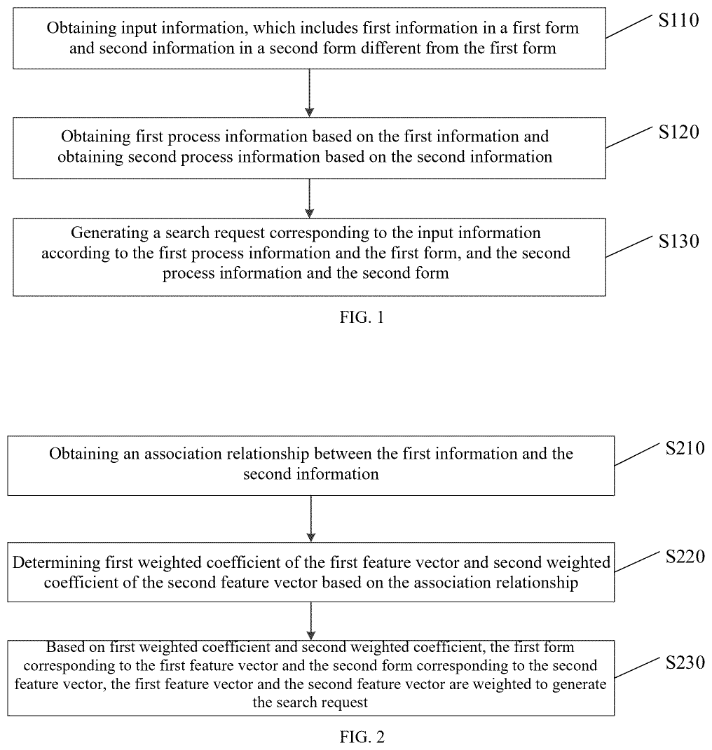

In certain embodiments, the present disclosure provides a processing method, as shown in FIG. 1, and the method includes:

Step S110, obtaining input information, where the input information includes first information in a first form and second information in a second form, the first form is different from the second form;

The input information may be information in different forms, including but not limited to the following forms: text, picture, audio, and video.

In certain embodiments, the first information in the first form may be text information in the form of text, and the second information in the second form may be picture information in the form of pictures.

In certain embodiments, the first information in the first form may be audio information in the form of audio, and the second information in the second form may be video information in the form of video.

The different forms of information provided may be combined into the first information and the second information.

In certain embodiments, the input information may include first information in a first form, second information in a second form, and third information in a third form. In certain embodiments, the input information may include text information, picture information, and audio information. During implementation, information in different forms may be combined to obtain first information, second information, and third information.

In certain embodiments, the input information may include first information in a first form, second information in a second form, third information in a third form, and fourth information in a fourth form. In certain embodiments, the input information may include text information, picture information, audio information, and video information.

During implementation, there is no restriction on the type of information, and there is no restriction on the type of input information.

Step S120: obtaining first process information based on the first information, and obtaining second process information based on the second information;

The first process information may be the first feature information corresponding to the first information obtained by extracting features from the first information; the second process information may be the second feature information corresponding to the second information obtained by extracting features from the second information.

In certain embodiments, feature extraction may be performed for different types of data such as text, pictures, audio, and video to obtain respective feature representations. That is, the multimodal data is converted into a feature representation form that may be understood and processed by a computer.

Step S130: Generating a search request corresponding to the input information according to the first process information and the first form, and the second process information and the second form.

The search request includes request information for searching in a database.

During an implementation process, information from different forms (different modalities of data) may be mapped into a shared semantic space for subsequent fusion and analysis. At this stage, a cross-modal attention model based on deep learning may be used to realize the mapping relationship between modalities. Complex relationship between different modalities of data may be learned and correspondence relationship between modalities may be discovered during the learning process. By introducing the attention mechanism, these models can better handle the heterogeneity and correlation between different modalities of data, thereby achieving more accurate modal mapping.

After the mapping between forms (modalities) is performed, the next step is to fuse the information of different modalities into a unified feature representation for subsequent analysis and processing. In the feature fusion process, considering the importance and contribution of different modal features, the weighted average method may be used to convert the data of different modalities into a unified semantic space and fuse them into a unified feature representation, that is, a unified multimodal vector (embedding).

During an implementation process, the fused multimodal vector may be used as the search request corresponding to the input information.

In certain embodiments of the present disclosure, the input information is obtained, and the input information includes first information in a first form and second information in a second form, and the first form is different from the second form; first process information is obtained according to the first information, and second process information is obtained according to the second information; a search request corresponding to the input information is generated according to the first process information and the first form, and the second process information and the second form. In this way, it is possible to generate search requests according to information in different forms and enrich the information forms included in the search requests; further, by using multimodal information as search requests, more comprehensive and diverse search results may be provided to meet users' more extensive and complex information needs. The fusion and collaboration between information in different forms make the search results richer and more diverse, thereby better meeting the needs of users. By integrating information in different forms, the accuracy and relevance of search results are improved, and the search experience is improved. Users may use search requests to find information more quickly, the time cost of information retrieval may be reduced, and search efficiency and satisfaction may be improved.

In certain embodiments, the term “search” may be interchangeable with the term “search” in that a search system may be referred to as a retrieval system and in that a document search may be referred to as a document retrieval.

In certain embodiments, the processing method includes:
Converting the first information into third information in a third form;

In certain embodiments, the third form is the same as the second form. In certain embodiments, the first information may be picture information, and the second information may be text information. The picture may be identified to obtain text information describing the picture, and the text information thus identified from the picture may be used as the third information.

In certain embodiments, the third form is different from the second form. In certain embodiments, the first information may be text information: “Search for an introduction video of a scenic spot”, the second information may be a photo of the scenic spot, and the third information may be related video information of the scenic spot.

The step S120 “obtaining first process information according to the first information, and obtaining second process information according to the second information” may be implemented by:
obtaining the first process information according to the first information, obtaining the second process information according to the second information, and obtaining the third process information according to the third information;

In certain embodiments, the first information may be “search for dog pictures”, the second information may be pictures including dogs, and the third information may be pictures of dogs generated based on the first information. In an implementation process, the first feature vector corresponding to “search for dog pictures” may be obtained based on the first information; the second information may be the second feature vector corresponding to the dog pictures; the third information may be the third feature vector corresponding to the generated dog pictures.

Correspondingly, the step S130 “generating a search request corresponding to the input information according to the first process information and the first form, and the second process information and the second form” may be implemented by:

Generating a search request corresponding to the input information according to the first process information and the first form, the second process information and the second form, and the third process information and the third form, wherein the third form is the same as the second form, or the third form is different from the second form.

During an implementation process, a search request may be generated according to the first form, the second form and the third form based on the first feature vector generated by the first information, the second feature vector generated by the second information, and the third feature vector generated by the third information.

In certain embodiments of the present disclosure, the first information is converted into the third information in the third form; the first process information is obtained according to the first information, the second process information is obtained according to the second information, and the third process information is obtained according to the third information; a search request corresponding to the input information is generated according to the first process information and the first form, the second process information and the second form, and the third process information and the third form. In this way, a richer information form of the search request may be achieved, and more search results matching the search request may be retrieved.

In certain embodiments, the step S120 “obtaining the first process information according to the first information and obtaining the second process information according to the second information” may be implemented by:
Step 123, converting the first information into a first feature vector;
Step 123, converting the second information into a second feature vector;
In an implementation process, the information forms include text, pictures, audio, video, or the like. For different types of data such as text, pictures, audio, video, or the like, feature extraction is performed as follows:

Text feature extraction: Text data usually exists in the form of word sequences, so a common method is to use pre-trained word embedding models (such as Word2Vec, GloVe, FastText) to convert text into fixed-dimensional word vector representations. These word vectors may capture the semantic and contextual information between words and establish a representation for text data in a continuous vector space.

Image feature extraction: For image data, Convolutional Neural Networks (CNN) (such as VGG, ResNet and other models) may extract high-level feature representations from images through multi-layer convolution and pooling operations. These features usually have abstract representations of information such as objects, textures, shapes, or the like in the image, providing a basis for semantic understanding of image data.

In certain embodiments, the term “image” may be interchangeable with the term “photo” or “picture.”

Audio feature extraction: Mel-Frequency Spectrum (MFC) and Mel Frequency Cepstrum Coefficient (MFCC) are used to extract the spectral information and acoustic features of audio. Linear predictive coding is used to decompose audio signals into linear filters and residual signals, and the vocal tract information of speech is extracted. The spectrogram method is used to convert audio signals into time-frequency images, reflecting the changes in audio in time and frequency.

Video feature extraction: 3D convolution neural network is used to perform three-dimensional convolution operation on video data to extract the spatiotemporal features of the video. The optical flow method is used to estimate the motion information between video frames and capture the motion trajectory of objects in the video. Frame Difference method is used to calculate the difference between adjacent video frames and to extract dynamic change information in the video. Video histogram features are used to count the pixel distribution in the video frame and to extract the color and brightness features of the video.

Correspondingly, the step S130 “generating a search request corresponding to the input information according to the first process information and the first form, and the second process information and the second form” may be implemented by:

Generating the search request according to the first feature vector, the first form corresponding to the first feature vector, the second feature vector and the second form corresponding to the second feature vector.

In an embodiment of the present disclosure, the first information is converted into a first feature vector; the second information is converted into a second feature vector; the search request is generated according to the first feature vector, the first form corresponding to the first feature vector, the second feature vector and the second form corresponding to the second feature vector. In this way, it is possible to integrate information of different forms into a search request so that the search request may reflect the input information in multiple forms.

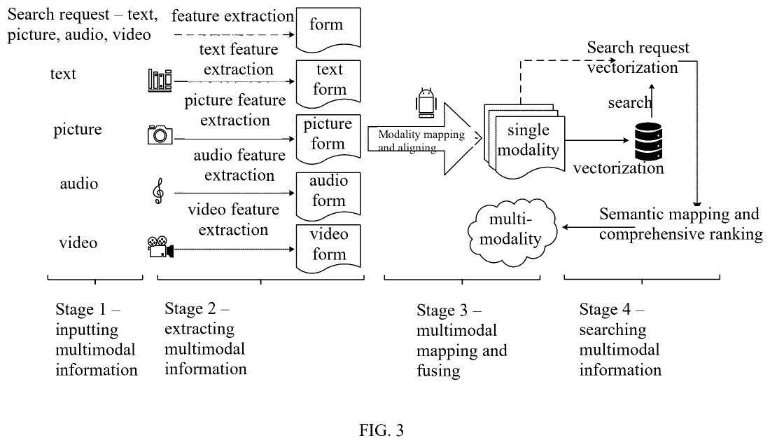

In certain embodiments, as shown in FIG. 2, the step “generating the search request according to the first feature vector, the first form corresponding to the first feature vector, the second feature vector and the second form corresponding to the second feature vector” may be implemented by:

Step S210, obtaining an association relationship between the first information and the second information;

In certain embodiments, the first information may be “dog” and the second information may be a picture including a dog, then the first information and the second information have a high association. The first information is “search for the breed of dog in the picture” and the second information is a picture including a dog, then the weight of the second information may be greater than the weight of the first information.

Step S220, determining the first weighted coefficient of the first feature vector and the second weighted coefficient of the second feature vector based on the association relationship;

For example, when the first information is “dog” and the second information may be a picture including a dog, it may be determined that the first weighted coefficient and the second weighted coefficient are both 0.5.

When the first information is “search for dog breeds in pictures” and the second information is a picture including a dog, the first weighted coefficient may be determined to be 0.25 and the second weighted coefficient may be determined to be 0.75.

Step S230: Based on the first weighted coefficient and the second weighted coefficient, the first form corresponding to the first feature vector and the second form corresponding to the second feature vector, the first feature vector and the second feature vector are weighted to generate the search request.

In certain embodiments of the present disclosure, the association relationship between the first information and the second information is obtained; based on the association relationship, the first weighted coefficient of the first feature vector and the second weighted coefficient of the second feature vector are determined; based on the first weighted coefficient and the second weighted coefficient, the first form corresponding to the first feature vector and the second form corresponding to the second feature vector, the first feature vector and the second feature vector are weighted to generate the search request. In this way, the obtained search request is more likely to reflect the search results.

In certain embodiments, the step S220 “determining the first weighted coefficient of the first feature vector and the second weighted coefficient of the second feature vector based on the association relationship” may be implemented by:

Step 221, determining the search form of the search results based on the input information, where the search form is the first form or the second form;

The input information may be parsed to determine the search form of the search results that the user wants to obtain. In certain embodiments, when the text information of the input information is “search for pictures of dogs with a breed of French bulldog,” it may be determined that the search form of the search results is pictures.

Step 222, determining the first weighted coefficient and the second weighted coefficient based on the search form and the association relationship.

When it is determined that the search form is the same as the first form, the first weighted coefficient may be adjusted to increase, when it is determined that the search form is the same as the second form, the second weighted coefficient may be adjusted to increase, to improve the accuracy of the search.

During an implementation process, in addition to considering the search form, the association relationship between the first information and the second information may also be considered to determine the first weighted coefficient and the second weighted coefficient based on the search form and the association relationship.

In certain embodiments of the present disclosure, the search form of the search results is determined based on the input information; the first weighted coefficient and the second weighted coefficient are determined based on the search form and the association relationship. In this way, the search request generated by considering the first weighted coefficient and the second weighted coefficient determined by the search form may improve the accuracy of the search.

FIG. 3 is a flow diagram of a multimodal search provided in certain embodiments of the present disclosure. As shown in FIG. 3, the flow diagram includes the four stages: Stage 1, input of multimodal information; Stage 2, extraction of multimodal information; Stage 3, mapping and fusion of multimodal information; Stage 4, search of multimodal information.

### Stage 1, Inputting Multimodal Information;

The type of multimodal information to be retrieved is determined, such as text, pictures, audio, video, or the like. The type of multimodal data to be retrieved is determined based on a particular application scenario and user's intentions. The format of text information includes but is not limited to: WORD, PDF, TXT, PPT; the format of picture information includes but is not limited to: JPG, PNG, TIFF; the format of audio information includes but is not limited to: MP3, WA, AAC; the format of video information includes but is not limited to: MP4, MOV, MKV.

### Stage 2, Extracting Multimodal Information;

For different types of data such as text, pictures, audio, and video, feature extraction is performed separately to obtain their respective feature representations. The work of this stage is to convert the original multimodal data into a feature representation that may be understood and processed by the computer.

In certain embodiments, feature extraction may be performed on different modalities of data such as text T, picture P, audio A, and video V in the input information, and they may be converted into feature vector tokens of corresponding types, where:
The text feature vector is recorded as T, expressed as T=[t₁, . . . , tₘ];
The image feature vector is recorded as P, expressed as P=[p₁, . . . , pₙ];
The audio feature vector is recorded as A, expressed as A=[a₁, . . . , aₖ];
The video feature vector is recorded as V, expressed as V=[v₁, . . . , vₗ].

### Stage 3: Multimodal Mapping and Fusing;

Multimodal mapping stage: Information from different modalities of data is mapped into a shared semantic space for subsequent fusion and analysis. At this stage, a cross-modal attention model based on deep learning may be used to realize the mapping relationship between modalities. The system may learn the relationship between different modalities of data and discover the correspondence relationship between modalities during the learning process. By introducing the attention mechanism, these models may better handle the heterogeneity and correlation between different modalities of data, thereby achieving more accurate modal mapping.

Multimodal fusion stage: After the mapping between modalities is completed, the next step is to fuse the information of different modalities into a unified feature representation for subsequent analysis and processing. In the feature fusion process, the importance and contribution of different modal features are considered, and the weighted average method is used to convert the data of different modalities into a unified semantic space and fuse them into a unified feature representation, that is, a unified multimodal vector (embedding).

Unified multimodal storage: After generating unified multimodal vectors (embeddings) for each text, image, audio, and video, these embeddings are saved in the database together with the corresponding file path components.

During an implementation process, information from different modalities of data may be mapped into a shared semantic space to make use of the information of each different modalities of data. To this end, all possible modal feature vector tokens may be combined individually or in pairs, with a total of 10 combinations, such as T, P, A, V, TP, TA, TV, PA, PV and AV. In certain embodiments, TP represents the mapping of text and image feature vector tokens, that is, TP=[t₁, . . . , tₘ, p₁, . . . , pₙ], and PV represents the mapping of image and video feature vector tokens, that is, PV=[p₁, . . . , pₙ, v₁, . . . , vₗ].

After performing the mapping between different modalities, the information of different modalities of data may be fused into a unified multimodal vector, denoted as TPAV. This vector contains four-dimensional tokens vectors of text T, image P, audio A and video V. Considering the importance and contribution of different modal features, the system defines a four-dimensional fusion function to perform a weighted average of the corresponding modal data dimensions on the 10 mapped feature vector tokens:

$$\begin{matrix}F ( T ) = {a}_{1} T + {a}_{2} TP + {a}_{3} TA + {a}_{4} TV ; \\ F ( P ) = {b}_{1} P + {b}_{2} TP + {b}_{3} PA + {b}_{4} PV ; \\ F ( A ) = {c}_{1} A + {c}_{2} TA + {c}_{3} PA + {c}_{4} AV ; \\ F ( V ) = {d}_{1} V + {d}_{2} TV + {d}_{3} PV + {d}_{4} AV ;\end{matrix}$$

Among them, a₁, a₂, a₃, a₄ are the weighted coefficients or weighted average coefficients of T, TP, TA, and TV related to the text dimension, b₁, b₂, b₃, and b₄ are the weighted coefficients or weighted average coefficients of P, TP, PA, and PV related to the image dimension, c₁, c₂, c₃, and c₄ are the weighted coefficients or the weighted average coefficients of A, TA, PA, and AV related to the audio dimension, and d₁, d₂, d₃, and da are the weighted coefficients or weighted average coefficients of V, TV, PV, and AV related to the video dimension. In this way, the feature vector tokens of different modalities of data may be converted into a four-dimensional unified multimodal vector TPAV. The four groups of weighted coefficients may be set according to particular needs, or determined according to the contribution of different forms of input information to the search results.

### Stage 4: Searching Multimodal Information;

Feature extraction and query conversion: After a query is given, the feature extraction and feature conversion of the stages 2 and 3 are performed to convert the query into a unified multimodal vector form of the query instruction (Query Embeddings), for example, the query vector.

Retrieve candidate set: After obtaining the query vector, search for candidate sets related to the query in the database. The candidate set contains documents, pictures, audio or video information related to the query vector.

After generating unified multimodal vectors for text, pictures, audio, and video, the system saves these vectors together with metadata consisting of the corresponding file paths into the database. When a user submits a query, the system uses the steps to extract and transform its features, and converts the query into a unified multimodal vector Query TPAV form of the query instruction. The system calculates the cosine similarity between the query instruction Query TPAV vector and some other TPAV vectors stored in the database in four dimensions, and performs weighted average summation to obtain the final similarity value. According to the similarity value, the system returns the file path information corresponding to some of the TOP N TPAVs before the value to obtain the search results (for example, related text, pictures, audio, and video). The calculation formula (1) is as follows:

$$Match ( TPAV ) = {M}_{1} Cos ( F ( QueryT ) , F ( T ) ) + {M}_{2} Cos ( F ( QueryP ) , F ( P ) ) + {M}_{3} Cos ( F ( QueryA ) , F ( A ) ) + {M}_{4} Cos ( F ( QueryV ) , F ( V ) ) ; \qquad ( 1 )$$

Among them, M1 to M4 are weighted coefficients, F(QueryT) is the text query vector, F(T) is the text vector stored in the database, F(QueryP) is the image query vector, F(P) is the image vector in the database, F(QueryA) is the audio query vector, F(A) is the audio vector stored in the database, F(QueryV) is the video query vector, and F(V) is the video vector in the database.

Semantic matching: For each candidate, its semantic similarity with the query vector is calculated. This may be achieved by calculating the cosine similarity between the query feature and the candidate feature.

Comprehensive sorting: The calculated semantic similarity is sorted or ranked.

Return results: Based on the results obtained from the comprehensive ranking, the top-ranked candidates are returned to the user as the search results. Usually, a threshold is set to determine the number of results returned based on the user's preferences and system requirements.

The weighted correlation coefficients are determined as follows:

The weighted correlation coefficients (a₁ to d₄, M₁ to M₄) may be trained and confirmed by minimizing the loss function. For example, a triple loss function may be used to drive model learning to obtain that similar samples are closer in the embedding space and dissimilar samples are farther away. The system constructs a triple, including an anchor sample, a positive sample, and a negative sample, where the anchor sample and the positive sample are from the same category, while the negative sample is from a different category. The goal of the loss function is to make the distance between the anchor sample and the positive sample as small as possible, and at the same time make the distance between the anchor sample and the negative sample as large as possible. The loss function (2) is defined as follows:

$$L ( Xa , Xp , Xn ) = max ( 0 , d ( Xa , Xp ) - d ( Xa , Xn ) + α ) ; \qquad ( 2 )$$

Among them, Xa is the multimodal vector representation of the anchor sample, Xp is the multimodal vector representation of the positive sample, Xn is the multimodal vector representation of the negative sample, and d (,) represents the distance measurement function between samples, which may be cosine similarity. α is the edge value, which is used to control the distance interval between positive and negative samples to obtain sufficient separation in the embedding space.

Anchor samples are samples that are fixed during the training process and are used to calculate the loss function. Positive samples are samples that are similar to anchor samples, while negative samples are samples that are dissimilar to anchor samples. Through training, the model is trained to minimize the distance between anchor samples and positive samples and maximize the distance between anchor samples and negative samples, so that the model may learn better feature representation.

In certain embodiments, the anchor sample may be a book, the positive sample may be other books similar to the book, and the negative sample may be other books unrelated to the book. Through such sample pairs, the system may learn how to classify similar books into one category and how to distinguish dissimilar books, thereby improving the accuracy and effect of retrieval. In certain embodiments of the present disclosure, multimodal information extraction adopts a series of feature extraction methods for different modal information such as text, pictures, audio, and video, and converts them into a unified feature representation. For text information, not only the semantic meaning of words is considered, but also the syntactic structure and context information are combined for feature extraction; for picture information, convolutional neural network (CNN) is used to extract visual features to capture the high-level representation of the image; for audio information, acoustic features are extracted using methods such as Mel spectrum features; and for video information, 3D convolutional neural network (3D CNN) is used for feature extraction in combination with spatiotemporal information. It may integrate different modal information such as text, pictures, audio, and video to achieve cross-modal intelligent retrieval. The process is no longer limited to a single modal information, and users may obtain more comprehensive and rich search results by inputting data in multiple forms.

The mapping and fusion between modalities use a cross-modal attention network model to map different modal information to a unified semantic space and achieve efficient fusion of cross-modal information. This process not only takes into account the heterogeneity between different modalities, but also makes use of the commonality and correlation between modalities, thereby achieving an organic combination and deep fusion of information. Through the learned shared representation, the semantic associations between different modal information are better captured and expressed, providing richer and more accurate semantic information for subsequent semantic matching and search.

Semantic matching and comprehensive sorting, in a unified semantic space, by calculating the similarity between different modal information, causes a cross-modal intelligent search to be realized. Through the fusion and semantic matching of multimodal information, the accuracy and relevance of search results may be improved, and the search experience may be improved. Users may find the required information more quickly, reduce the time cost of information retrieval, and improve search efficiency and satisfaction. Taking into account the similarity of multimodal information and user needs, the search results are comprehensively sorted through a series of algorithms and models. This process not only considers the correlation between each modal information, but also combines the personalized needs and search history of users, thereby providing more accurate, personalized and diversified search results.

In certain embodiments, the database corresponding to the search request includes at least one information block obtained by dividing the stored information based on different forms and preset information amounts, and each of the information blocks is corresponding to a first index and a second index, where the first index is the summary information obtained by extracting the information in the information block, and the second index is the information in the information block.

During an implementation process, document contents stored in the database may be divided into information blocks of appropriate size according to certain rules. This division may be based on the length of the document, paragraph structure, different forms of the document or specific tags to obtain that each information block (document block) contains a moderate amount of information, neither too large to reduce processing efficiency nor too small to cause information loss. The divided document blocks are used as the basic unit in the system for subsequent processing and retrieval.

After performing the document content segmentation and vectorization, these document blocks may be hierarchically indexed, that is, the first index and the second index are set as follows:

Set the first index: The first index is composed of the summary of the document block and several questions generated by the large language model (LLM), which is used to quickly filter out relevant document blocks. For each document block, summary information is extracted, the summary information including key sentences or paragraphs, and certain information related to the document content. LLM is used to generate questions that may be related to the document content. These questions may be keywords extracted from the summary or some common questions related to the document content. The summary information of the document block and the generated questions are combined together to construct an index entry and stored in the first index.

Set the second index: The second index consists of document blocks and is used to further retrieve related document blocks. Document blocks are stored in the second index to form a library of document blocks. The second index is used to perform a deeper document block search when the first index may not meet the retrieval requirements.

In certain embodiments of the present disclosure, the database includes at least one information block obtained by dividing the stored information based on different forms and preset information amounts, and each of the information blocks is correspondingly set with a first index and a second index. In this way, the amount of information contained in each information block may be moderate, neither too large to reduce processing efficiency nor too small to cause information loss. The hierarchical index design improves search efficiency and reduces search time.

In certain embodiments, the processing method includes:

Step S140, based on the search request, matching the first index in the database to obtain the search result;

During an implementation process, the vector relevant to the search request may be matched to the vector relevant to the first index in the data to obtain the information block corresponding to the first index as the search result.

Or,

Step S150, based on the search request, matching the first index in the database to obtain at least one information block;

In certain embodiments, the term “match” may be interchangeable with the term “align” or the term “correspond” or the term “compare.”

During an implementation process, the vector relevant to the search request may correspond to the vector corresponding to the first index in the data to obtain at least one information block corresponding to the first index, that is, to obtain the content of the information block. If it is determined that the content does not satisfy the search request, step S160 may be executed to conduct a deeper search in the second index.

Step S160, based on the search request, at least one piece of information is retrieved from the at least one information block to obtain the search result.

During an implementation process, the search request may be used to further search in at least one information block to obtain at least one piece of information as a search result.

In certain embodiments of the present disclosure, the search result is obtained based on the search request corresponding to the first index in the database; or based on the search request corresponding to the first index in the database, at least one information block is obtained; based on the search request corresponding to at least one piece of information in the at least one information block, the search result is obtained. In this way, different search requirements may be met, and the required information block may be retrieved, or a piece of information may be further retrieved.

In certain embodiments, the processing method includes:

Step S170, in response to the amount of information in the search result being less than the information amount threshold, at least one target information block associated with the second index is determined based on the second index corresponding to the search result;

When it is determined that the amount of information in the search results is small, the most relevant second index and at least one target information block formed by expansion of the context of the second index may together form richer information content.

Step S180, updating the search results based on the at least one target information block.

In certain embodiments of the present disclosure, when the amount of information in the search results is less than the information amount threshold, at least one target information block associated with the second index is determined based on the second index corresponding to the search results; and the search results are updated based on the at least one target information block. In this way, it is possible to expand at least one target information when the amount of information retrieved is small, and provide users with richer information content as search results.

In certain embodiments, the processing method includes:

Step S190, the information blocks corresponding to different forms in the search results are sorted and output based on the first form and the second form, where the search results are determined in the database based on the search request.

During an implementation process, the information blocks corresponding to different forms in the search results may be sorted and output based on the first form and the second form in the input information. In certain embodiments, when the first form is text and the second form is picture, the information blocks in text and picture in the search results may be prioritized and output.

In certain embodiments of the present disclosure, the information blocks corresponding to different forms in the search results are sorted and output based on the first form and the second form. In this way, since the input information includes the first form and the second form, the information blocks corresponding to different forms in the search results may be sorted and output based on the form in the input information, which more accurately reflect the user's intentions.

In certain embodiments, the “sorting and outputting the information blocks corresponding to different forms in the search results based on the first form and the second form” in the step S190 may be implemented by:

Step 191, corresponding the information form of each information block in the search results with the first form and the second form, and determining the first correlation coefficient of each information block;

Step 192, corresponding the summary information relevant to each information block in the search results with the search request by keywords, and obtaining the second correlation coefficient of each information block;

Based on the keyword search algorithm, the search request and the summary of the document block may correspond to the keywords to calculate the second correlation coefficient. This method is suitable for simple semantic matching and is relatively fast.

Step 193, semantically corresponding the information of each information block in the search results with the search request, and obtaining the third correlation coefficient of each information block;

Based on the semantic retrieval algorithm, LLM may be used to semantically correspond the search request with the information block to calculate the third correlation coefficient. This method may more accurately capture the semantic information of the document content and improve the accuracy and relevance of the search results.

Step 194, weighted averaging the first correlation coefficient, the second correlation coefficient and the third correlation coefficient to obtain the target correlation coefficient of each information block;

Step 195, sorting the target correlation coefficients to obtain the sorting results of the information blocks in the search results.

In certain embodiments of the present disclosure, the information blocks in the search results are sorted based on the form of the input information, keyword mapping and semantic mapping. In this way, when sorting the information blocks in the search results, the information blocks corresponding to different forms in the search results are sorted based on the form in the input information, and the keyword information and semantic information of the information blocks in the search results may be more accurately captured for sorting, which improves the accuracy and relevance of the search result sorting.

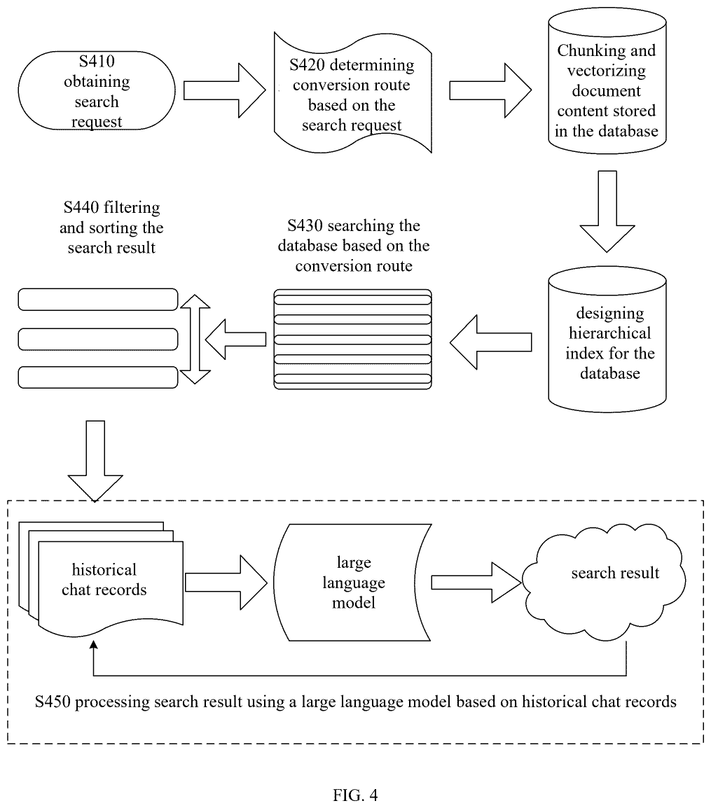

FIG. 4 is a flowchart of a document search process based on a large language model provided by an embodiment of the present disclosure. As shown in FIG. 4, the process includes: Step S410, obtaining a search request;

Step S420, determining a conversion route according to the search request;

The conversion route adopts different processing methods according to the complexity of the search request to improve the search efficiency and accuracy.

In certain embodiments, and when the search request is determined to be a simple query, the route does not need to be converted. The user's search request is directly submitted to the document retrieval system to perform subsequent corresponding retrieval operations. A simple query may be a single-step query with clear query information.

When it is determined that the search request is of multiple steps, the system uses sub-problem decomposition to decompose the search request into multiple separate sub-queries. The purpose of this is to decompose the complex search request task into multiple simple sub-tasks, each of which may be retrieved independently, and the results of each sub-query is integrated or combined to obtain an integrated search result. In certain embodiments, and when the user's search request is “how to learn programming and master data structures and algorithms”, the system decomposes the search request into two sub-queries, “learn programming” and “master data structures and algorithms”, performs search operations separately, and merges or integrates the results.

When the search request is determined to be of multiple unrelated queries, that is, when the search request contains multiple sub-queries that are unrelated to each other, the system converts the search request into multiple multi-step queries. The system may treat each sub-query as an independent query task and process them separately. In certain embodiments, and when the user's query is “when is the latest model of Apple mobile phone released” and “how to make a delicious pizza”, the system processes these two queries separately instead of combining them into a compound query, at least because the two queries appear to be unrelated or less related to each other.

Before the retrieval system performs subsequent search request operations, the retrieval system may perform the following operation on the database:

### Operation 1: Chunking and Vectorizing Document Content Stored in the Database;

Document content chunking: The system divides document content stored in the database into information blocks of appropriate size according to certain rules. This division may be based on the length of the document, paragraph structure, or particular tags to obtain that the amount of information contained in each document block is moderate, neither too large to reduce processing efficiency nor too small to cause information loss. The divided document blocks are used as the basic units in the system for subsequent processing and retrieval.

Vectorization: The purpose of vectorizing each document block is to convert text information into numerical form to facilitate semantic matching and similarity calculation. Use pre-trained large language models such as BERT, GPT, or the like to vectorize each document block. By inputting the text into the LLM, its corresponding semantic vector representation is obtained.

### Operation 2: Designing Hierarchical Index for Database;

After the document content segmentation (chunking) and vectorization are performed, hierarchical index is designed for these document blocks, as follows:

Set the first index: The first index is composed of the summary of the document block and several questions generated by LLM, which is used to quickly filter out relevant document blocks. For each document block, its summary information is extracted, the summary information including key sentences or paragraphs, and some important information related to the document content. LLM is employed to generate some questions that may be related to the document content. These questions may be keywords extracted from the summary or some common questions related to the document content. The summary information of the document block and the generated questions are combined or integrated to build an index entry and the index entry is stored in the first index.

Set the second index: The second index is composed of document blocks, and is used to further retrieve relevant document blocks. Document blocks are stored in the second index to form a library of document blocks. The second index is used for more in-depth document block retrieval when the first index does not meet the search request.

Step S430, searching in the database based on the conversion route;

The search phase includes information filtering and information enhancement. The search phase refers to filtering out information related to the search request from a large number of document blocks, and enhancing the search results to provide more accurate and rich retrieval results. The search phage includes the following two steps of search:

The first step of search, using the summary and hypothetical questions of the first index to quickly filter the candidate document blocks;

During an implementation process, the system uses the document block summary information stored in the first index and the hypothetical questions associated with it to quickly filter the candidate document blocks. The summary information may help the system quickly understand the subject and key points of the document, while the hypothetical questions may guide the system to more accurately map the user's query intent.

The second step of search: According to the size of the document, the search is divided into the following two situations for processing;

Scenario 1: Search operation when the document block is large: When the candidate document block is large, the system adopts a method of embedding each sentence separately, and inputs each sentence in the document block into the language model for vectorization. Combined with the search request, the system further retrieves the sentences most relevant to the query. These sentences may contain key information of the search request, which helps to improve the accuracy of the search results. The system expands the most relevant single sentence and its surrounding context by a certain number of sentences to form richer information content, and sends them together to LLM for further processing and analysis.

Scenario 2: Search operation when the document block is small: When the candidate document block is small, the system adopts a method of expanding the front and back document blocks, and sends several document blocks before and after the candidate document block together to LLM for processing. The purpose of this is to provide more contextual information to help LLM better understand and analyze the document content, thereby improving the quality and accuracy of search results.

Step S440, filtering and sorting the search result;

The search results may be summarized, including re-filtering and re-ranking the search results.

The multiple document blocks searched out in step S430 are filtered and sorted to obtain a more desirable quality of the search results and improve the search efficiency. S430 may include the following two steps:
1. Duplicate content removal and spam content filtering: The system removes duplicate document blocks by comparing the document content in the search results to obtain the diversity and effectiveness of the results. Certain spam content filtering technologies, such as rule-based filtering, classification filtering of machine learning models, or the like may be used to exclude document blocks that are irrelevant or less relevant to the search request or low-quality from the search results.
2. Re-ranking phase: includes the following two steps:
(1) Calculate the relevance value: The system uses two methods to calculate the relevance value of each document block and the search request, namely the keyword-based retrieval algorithm and the semantic retrieval algorithm.
(A) Keyword-based retrieval algorithm: The system corresponds to the search request with the summary of the document block by keywords and calculates the relevance value. This method is suitable for simple semantic matching and is relatively fast, but in certain circumstances, it may ignore the semantic information of the document content.
(B) Semantic retrieval algorithm: The system uses LLM to semantically correspond the search request and the document block and calculates the relevance value. This method may more accurately capture the semantic information of the document content and improve the accuracy and relevance of the search results.
(2) Weighted average to obtain the document block relevance value: The system performs a weighted average of the two calculated relevance values to obtain the document block relevance value. By adjusting the weights, the impact of keyword mapping and semantic mapping on the search results may be balanced, further improving the quality and accuracy of the search results.

Step S450, processing search result using a large language model based on historical chat records;

During an implementation process, chat history data may be embedded in LLM, and search results may be processed based on LLM.

The chat history system may retrieve historical contexts related to the search request, and send the historical information together with the final retrieved document block and search request to LLM, so as to provide more coherent and personalized answers. The operation process includes:
1. Retrieve chat history context: When the user initiates a search request, the system retrieves the user's chat history records from the chat history vector database, including previous conversation content, query history, or the like. The historical information may provide valuable context information to help the system better understand the user's intentions and background.
2. Integrate search requests and search document blocks: The system integrates the user's current search request with the searched related document blocks to form an integrated query context. This query context includes the user's query content and the relevant information searched by the system, providing richer input for LLM.
3. Send to LLM for processing: The integrated query context and search results are sent to LLM for processing. LLM may use this information for semantic understanding and reasoning to generate more coherent and personalized answers.
4. Re-update of chat history data: Answers given by LLM to search requests together with the search request are re-embedded into the chat history vector database as new historical records, so as to better understand and respond to the search request next time.

Certain embodiments of the present disclosure provide a document retrieval enhancement solution based on a large language model. The solution includes a series of retrieval enhancement processes including document content segmentation and vectorization, hierarchical index design, search request conversion routing, search information filtering and information enhancement, re-filtering and re-ranking of search summaries, and chat history data embedding.

The advantages of adopting this solution are as follows:
1. Semantic understanding and matching: more accurate semantic understanding and matching are achieved through a large language model, improving the relevance and accuracy of retrieval results.
2. Multi-layer indexing improves retrieval efficiency: hierarchical index design and multi-step search strategy improve retrieval efficiency and reduce retrieval time.
3. Personalization and history engine: combined with search request history and personalized needs, provide search results and answers that are closer to user intentions.
4. Comprehensive filtering and sorting: multiple strategies are used to remove duplicate content and filter junk content, while dual sorting based on keywords and semantics improves the quality of results.
5. System optimization and learning: the embedding of LLM history records and query conversion routing provides the system with opportunities for optimization and learning, and improves search results and user experience.

Certain embodiments of the present disclosure provide a processing device, which includes the modules included, each module may include a submodule, each submodule may include a unit, and may be implemented by a processor in an electronic device; the processing device may be implemented by a logic circuit; in an implementation process, the processor may be a central processing unit (CPU), a microprocessor (MPU), a digital signal processor (DSP) or a field programmable gate array (FPGA), or the like.

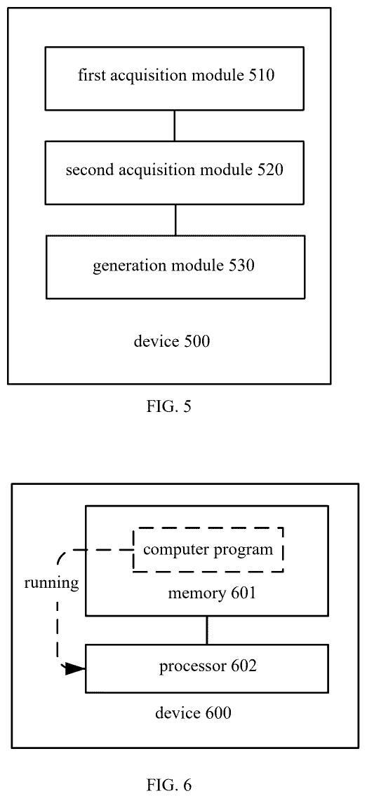

FIG. 5 is a schematic diagram of the composition structure of the processing device provided by certain embodiments of the present disclosure. As shown in FIG. 5, the device or equipment 500 includes:

A first acquisition module 510, which is used to obtain input information, and the input information includes first information in a first form and second information in a second form, and the first form is different from the second form;

A second acquisition module 520, which is used to obtain first process information according to the first information, and obtain second process information according to the second information;

A generation module 530, which is used to generate a search request corresponding to the input information according to the first process information and the first form, and the second process information and the second form.

In certain embodiments, the processing method includes a conversion module for converting the first information into third information in a third form; the second acquisition module 520 is also used to obtain the first process information according to the first information, obtain the second process information according to the second information, and obtain the third process information according to the third information; the generation module 530 is used to generate a search request corresponding to the input information according to the first process information and the first form, the second process information and the second form, and the third process information and the third form, where the third form is the same as the second form, or the third form is different from the second form.

In certain embodiments, the second acquisition module 520 includes a first conversion submodule and a second conversion submodule, where the first conversion submodule is used to convert the first information into a first feature vector; the second conversion submodule is used to convert the second information into a second feature vector; the generation module 530 is used to generate the search request according to the first feature vector, the first form corresponding to the first feature vector, the second feature vector, and the second form corresponding to the second feature vector.

In certain embodiments, the generation module 530 includes an acquisition submodule, a determination submodule and a generation submodule, where the acquisition submodule is used to acquire the association relationship between the first information and the second information; the determination submodule is used to determine the first weighted coefficient of the first feature vector and the second weighted coefficient of the second feature vector based on the association relationship; the generation submodule is used to perform weighted processing on the first feature vector and the second feature vector based on the first weighted coefficient and the second weighted coefficient, the first form corresponding to the first feature vector and the second form corresponding to the second feature vector, and generate the search request.

In certain embodiments, the determination submodule includes a first determination unit and a second determination unit, where the first determination unit is used to determine the search form of the search results based on the input information, where the search form is the first form or the second form; the second determination unit is used to determine the first weighted coefficient and the second weighted coefficient based on the search form and the association relationship.

In certain embodiments, the database corresponding to the search request includes at least one information block obtained by dividing the stored information based on different forms and preset information amounts, and each of the information blocks corresponds to a first index and a second index, where the first index is summary information obtained by extracting the information in the information block, and the second index is the information in the information block.

In certain embodiments, the processing device includes a first mapping module, or a second mapping module and a third mapping module, where the first mapping module is used to map or match the first index in the database based on the search request to obtain a search result; the second mapping module is used to match or map the first index in the database based on the search request to obtain at least one information block; the third mapping module is used to match or map at least one piece of information in the at least one information block based on the search request to obtain the search result.

In certain embodiments, the processing device includes a determination module and an update module, where the determination module is used to determine at least one target information block associated with the second index corresponding to the search result based on the second index corresponding to the search result when the information amount of the search result is less than the information amount threshold; the update module is used to update the search result based on the at least one target information block.

In certain embodiments, the processing device includes a sorting module, which is used to sort and output information blocks corresponding to different forms in the search result based on the first form and the second form, where the search result is determined in the database based on the search request.

In certain embodiments, the sorting module includes a first mapping submodule, a second mapping submodule, a third mapping submodule, a weighted average submodule and a sorting submodule, where the first mapping submodule is used to match or map the information form of each information block in the search results with the first form and the second form to determine the first correlation coefficient of each information block; the second mapping submodule is used to match or map the summary information corresponding to each information block in the search results with the search request for keywords to obtain the second correlation coefficient of each information block; the third mapping submodule is used to semantically match or map the information of each information block in the search results with the search request to obtain the third correlation coefficient of each information block; the weighted average submodule is used to weighted average the first correlation coefficient, the second correlation coefficient and the third correlation coefficient to obtain the target correlation coefficient of each information block; the sorting submodule is used to sort the target correlation coefficients to obtain the sorting results of the information blocks in the search results.

The description of the processing device is similar to the description of the processing method, and has similar beneficial effects as the processing method. For technical details not disclosed in the processing device of the present disclosure, relevant description of the processing method of the present disclosure may be referred to for understanding.

In certain embodiments of the present disclosure, the processing method is implemented in the form of a software function module and sold or used as an independent product, and may be stored in a computer-readable storage medium. Based on this understanding, the technical solution of certain embodiments of the present disclosure may be reflected in the form of a software product that contributes to the relevant technology. The computer software product is stored in a storage medium, including several instructions to enable an electronic device (which may be a mobile phone, tablet computer, laptop computer, desktop computer, or the like) to execute all or part of the methods described. The aforementioned storage medium includes: U disk, mobile hard disk, read-only memory (ROM), disk or optical disk, or the like, which may store program code. In this way, certain embodiments of the present disclosure are not limited to any particular combination of hardware and software.

Certain embodiments of the present disclosure provide a storage medium on which a computer program is stored, and when the computer program is executed by the processor, the steps in the processing method are implemented.

The present disclosure in certain embodiments provides an electronic device, and FIG. 6 is a schematic diagram of a hardware entity of the electronic device. As shown in FIG. 6, the hardware entity of the device 600 includes: a memory 601 and a processor 602, the memory 601 stores a computer program that may be executed on the processor 602, and the processor 602 implements the steps in the processing method when executing the program.

The memory 601 is configured to store instructions and applications executable by the processor 602, and may cache data to be processed or processed by the processor 602 and each module in the electronic device 600 (for example, image data, audio data, voice communication data and video communication data), which may be implemented by flash memory (FLASH) or random access memory (RAM).

The description of the storage medium and device embodiments is similar to the description of the method embodiments, and has similar beneficial effects as the method embodiments. For technical details not disclosed in the storage medium and device embodiments of the present disclosure, the description of the method embodiments of the present disclosure may be referred to for understanding.

When applicable, “an embodiment” or “one embodiment” mentioned refers to features, structures or characteristics related to certain embodiments of the present disclosure. Therefore, “in an embodiment” or “in one embodiment” when applicable does not necessarily refer to the same embodiment. In addition, these features, structures or characteristics may be combined in one or more embodiments in any suitable manner. In various embodiments of the present disclosure, the size of the sequence number of each process does not mean the order of execution, and the execution order of each process may be determined by its function and internal logic, and should not necessarily constitute any limitation on the implementation process of certain embodiments of the present disclosure. The sequence numbers of certain embodiments of the present disclosure are only for description and do not necessarily represent the advantages and disadvantages of certain embodiments.

When applicable, the terms “include” and “comprise” or any other variants thereof are intended to cover non-exclusive inclusion, so that a process, method, article or device including a series of elements includes not only those elements, but also other elements not explicitly listed, or also includes elements inherent to such process, method, article or device. In the absence of further restrictions, an element defined by the sentence “includes one . . . ” does not exclude the existence of other identical elements in the process, method, article or device including the element.

The disclosed devices and methods may be implemented in other ways. The device embodiments described above are only schematic. For example, the division of the units is only a logical function division. There may be other division methods in a particular implementation, for example, multiple units or components may be combined, or may be integrated into another system, or some features may be ignored, or not executed. In addition, the coupling, direct coupling, or communication connection between the components shown or discussed may be through some interfaces, and the indirect coupling or communication connection of the device or unit may be electrical, mechanical or via other forms.

The units described as separate components may or may not be physically separated, and the components displayed as units may or may not be physical units; they may be located in one place or distributed on multiple network units; some or all of the units may be selected according to particular projects to achieve the purpose of the scheme of this embodiment.

Functional units in certain embodiments of the present disclosure may be integrated in one processing unit, or each unit may be a separate unit, or two or more units may be integrated in one unit; the integrated units may be implemented in the form of hardware or in the form of hardware plus software functional units.

A person of ordinary skill in the technical field may understand that all or part of the steps of the processing method may be performed by hardware related to program instructions, and the program may be stored in a computer-readable storage medium, and when the program is executed, the steps of the processing method are executed; and the above storage medium includes: a mobile storage device, a read-only memory (ROM), a disk or an optical disk, and other media that may store program codes.

When the integrated unit of the present disclosure is implemented in the form of a software functional module and sold or used as an independent product, it may also be stored in a computer-readable storage medium. The technical solution of certain embodiments of the present disclosure may be embodied in the form of a software product, which is stored in a storage medium and includes a number of instructions for enabling an electronic device (which may be a mobile phone, tablet computer, laptop computer, desktop computer, or the like) to execute all or part of the processing method according to certain embodiments of the present disclosure. The storage medium includes: various media that may store program codes, such as mobile storage devices, ROM, magnetic disks or optical disks.

The methods disclosed in several method embodiments provided in the present disclosure may be combined without conflict to obtain new method embodiments.

The features disclosed in several product embodiments provided in the present disclosure may be combined without conflict to obtain new product embodiments.

The features disclosed in several method or device embodiments provided in present disclosure may be combined without conflict to obtain new method embodiments or device embodiments.

The description reflects an implementation method of present disclosure, but the protection scope of present disclosure is not limited thereto. Any technician familiar with this technical field may easily think of changes or replacements within the technical scope disclosed in present disclosure, which should be covered within the protection scope of present disclosure. The protection scope of the present disclosure shall be based on the protection scope of the claims.

What is claimed is:

1. A processing method, comprising:
obtaining input information, the input information including first information in a first form and second information in a second form, the first form being different from the second form;
obtaining first process information based on the first information, and obtaining second process information based on the second information; and
generating a search request corresponding to the input information based on the first process information and the first form, and the second process information and the second form.

2. The method of claim 1, further comprising:
converting the first information into third information in a third form,
wherein obtaining the first process information and obtaining the second process information includes: obtaining the first process information according to the first information, obtaining the second process information according to the second information, and obtaining third process information according to the third information, and
wherein generating the search request includes: generating the search request corresponding to the input information according to the first process information and the first form, the second process information and the second form, and the third process information and the third form, wherein the third form is the same as or different from the second form.

3. The method of claim 1, wherein obtaining the first process information and obtaining the second process information includes converting the first information into a first feature vector and converting the second information into a second feature vector, and
wherein generating the search request includes generating the search request according to the first feature vector, the first form, the second feature vector, and the second form.

4. The method of claim 3, wherein generating the search request includes:
acquiring an association relationship between the first information and the second information;
determining a first weighted coefficient of the first feature vector and a second weighted coefficient of the second feature vector based on the association relationship; and
based on the first weighted coefficient and the second weighted coefficient, the first form corresponding to the first feature vector, and the second form corresponding to the second feature vector, weighting the first feature vector and the second feature vector to generate the search request.

5. The method of claim 4, wherein determining the first weighted coefficient and the second weighted coefficient includes:
determining a search form of a search result based on the input information, the search form being the first form or the second form; and
determining the first weighted coefficient and the second weighted coefficient based on the search form and the association relationship.

6. The method of claim 1, wherein the search request is obtained from a database corresponding to the search request, the database includes information blocks obtained by dividing stored information based on different forms and preset information amounts, and each of the information blocks corresponds to a first index and a second index, the first index includes summary information obtained by extracting information in the information blocks, and the second index includes information in the information blocks.

7. The method of claim 6, further comprising:
obtaining the search result by mapping the search request with the first index in the database; or
obtaining the search result by mapping the search request with the first index in the database to obtain at least one information block; and obtaining the search request that maps at least one piece of information in the at least one information block.

8. The method of claim 7, further comprising:
in response to an information amount of the search result being less than an information amount threshold, determining at least one target information block associated with the second index; and
updating the search result based on the at least one target information block.

9. The method of claim 1, further comprising:
determining a search result in a database based on the search request; and
sorting and outputting information blocks of different forms in the search result based on the first form and the second form.

10. The method of claim 9, wherein sorting and outputting the information blocks includes:
mapping information form of each information block in the search result with the first form and the second form to determine a first correlation coefficient of each information block;
keyword mapping summary information corresponding to each of information blocks in the search result with the search request to obtain a second correlation coefficient of the each of information blocks;
semantically mapping information of the each of information blocks in the search result with the search request to obtain a third correlation coefficient of the each of information blocks;
weighted averaging the first correlation coefficient, the second correlation coefficient and the third correlation coefficient to obtain target correlation coefficients of the information blocks; and
sorting the target correlation coefficients to obtain a sorting result of the information blocks in the search result.

11. An electric device, comprising a memory storing computer program instructions, and one or more processors coupled to the memory and configured to execute the computer program instructions and perform:
obtaining input information, the input information including first information in a first form and second information in a second form, the first form being different from the second form;
obtaining first process information based on the first information, and obtaining second process information based on the second information; and
generating a search request corresponding to the input information based on the first process information and the first form, and the second process information and the second form.

12. The electric device of claim 11, wherein the processor is further configured to perform:
converting the first information into third information in a third form,
wherein obtaining the first process information and obtaining the second process information includes: obtaining the first process information according to the first information, obtaining the second process information according to the second information, and obtaining third process information according to the third information, and
wherein generating the search request includes: generating the search request corresponding to the input information according to the first process information and the first form, the second process information and the second form, and the third process information and the third form, wherein the third form is the same as or different from the second form.

13. The electric device of claim 11,
wherein obtaining the first process information and obtaining the second process information includes converting the first information into a first feature vector and converting the second information into a second feature vector, and
wherein generating the search request includes generating the search request according to the first feature vector, the first form, the second feature vector, and the second form.

14. The electric device of claim 13,
wherein generating the search request includes:
acquiring an association relationship between the first information and the second information;
determining a first weighted coefficient of the first feature vector and a second weighted coefficient of the second feature vector based on the association relationship; and
based on the first weighted coefficient and the second weighted coefficient, the first form corresponding to the first feature vector, and the second form corresponding to the second feature vector, weighting the first feature vector and the second feature vector to generate the search request.

15. The electric device of claim 14, wherein determining the first weighted coefficient and the second weighted coefficient includes:
determining a search form of a search result based on the input information, the search form being the first form or the second form; and
determining the first weighted coefficient and the second weighted coefficient based on the search form and the association relationship.

16. The electric device of claim 11, wherein the search request is obtained from a database corresponding to the search request, the database includes information blocks obtained by dividing stored information based on different forms and preset information amounts, and each of the information blocks corresponds to a first index and a second index, the first index includes summary information obtained by extracting information in the information blocks, and the second index includes information in the information blocks.

17. The electric device of claim 16, wherein the processor is further configured to perform:
obtaining the search result by mapping the search request with the first index in the database; or
obtaining the search result by: mapping the search request with the first index in the database to obtain at least one information block; and obtaining the search request that maps at least one piece of information in the at least one information block.

18. The electric device of claim 17, wherein the processor is further configured to perform:
in response to an information amount of the search result being less than an information amount threshold, determining at least one target information block associated with the second index; and
updating the search result based on the at least one target information block.

19. The electric device of claim 11, wherein the processor is further configured to perform:
determining a search result in a database based on the search request; and
sorting and outputting information blocks of different forms in the search result based on the first form and the second form.

20. A non-transitory computer-readable storage medium storing computer program instructions executable by at least one processor to perform:
obtaining input information, the input information including first information in a first form and second information in a second form, the first form being different from the second form;
obtaining first process information based on the first information, and obtaining second process information based on the second information; and
generating a search request corresponding to the input information based on the first process information and the first form, and the second process information and the second form.
